(19) United States
(12) Patent Application Publication
(10) Pub. No.: US 2012/0305310 A1
(43) Pub. Date: Dec. 6, 2012

(54) ELECTRONIC CABLE

(75) Inventors: Kei TAKAHASHI, Kanagawa (JP); Hirohisa KUBOTA, Saitama (JP); Tamotsu TETSUCHIKAWARA, Kanagawa (JP)

(73) Assignee: SONY COMPUTER ENTERTAINMENT INC., Tokyo (JP)

(21) Appl. No.: 13/485,995

(22) Filed: Jun. 1, 2012

(30) Foreign Application Priority Data
Jun. 3, 2011 (JP) 2011-125873

(51) Int. Cl. H01R 9/11

(52) U.S. Cl. 174/74 R

(57) ABSTRACT

A cable main includes an outer tube, a core wire, and an assisting wire. The assisting wire is less stretchable than the outer tube. Connectors provided at ends of the cable main fasten ends of the assisting wire at ends of the outer tube so as to restrain the ends of the outer tube from moving in a stretch direction of the outer tube. According to this structure, even when the outer tube is stretched, a load applied to a connecting part between the core wire and a terminal of the connector can be reduced.

### CROSS-REFERENCE TO RELATED APPLICATION

The present application claims priority from Japanese application JP 2011-125873 filed on Jun. 3, 2011 the content of which is hereby incorporated by reference into this application.

### BACKGROUND OF THE INVENTION

1. Field of the Invention

The present invention relates to an electronic cable used for electrical connection between electronic devices.

2. Description of the Related Art

Conventionally, an electronic cable for electrically connecting two electronic devices is used. For example, a portable electronic device disclosed in U.S. Patent Application Publication No. 2007/0202956 has a USB terminal and is connected to another electronic device via a USB cable.

The electronic cable includes a cable main having plural core wires and an outer tube covering the core wires, and a connector provided at an end of the cable main. The connector has a metallic case, and the end of the cable main is inserted in the case. Ends of the core wires extend further from an end of the outer tube and are soldered to terminals housed in the case.

### SUMMARY OF THE INVENTION

The outer tube is made of a flexible and stretchable resin. Therefore, the outer tube may stretch when the cable main is bent or stretched in the length direction thereof. However, since the core wires made of a conductor such as copper do not stretch, a load is applied to the connecting part between the core wires and the terminals when the outer tube stretches.

An electronic cable according to an aspect of the invention includes a cable main and connectors provided at both ends of the cable main. The cable main includes an outer tube that is stretchable in a length direction thereof, a core wire that is laid through the inside of the outer tube and has both ends thereof connected respectively to terminals provided in the connectors, and an assisting wire that is laid through the inside of the outer tube and is less stretchable than the outer tube. The connectors fasten the both ends of the assisting wire respectively to the both ends of the outer tube so as to restrain movement of the both ends of the outer tube in a stretch direction of the outer tube.

According to the electronic cable, stretching of the outer tube can be restrained even when the cable main is bent or stretched in the length direction thereof. Therefore, a load applied to the connecting part between the ends of the core wire and the terminals can be reduced.

### BRIEF DESCRIPTION OF THE DRAWINGS

FIG. 1 is a plan view of an electronic cable according to an embodiment of the invention.

FIG. 2 is a perspective view of a shield case provided on a connector of the electronic cable.

FIG. 3 is a horizontal sectional view of the connector.

FIG. 4 is a side view of a bushing provided on the electronic cable.

FIG. 5A and FIG. 5B are sectional views of the bushing.

FIG. 6 is a side view showing the state of the bushing when the electronic cable is bent.

FIG. 7 shows a modification of the shield case provided on the connector.

### DETAILED DESCRIPTION OF THE PREFERRED EMBODIMENTS

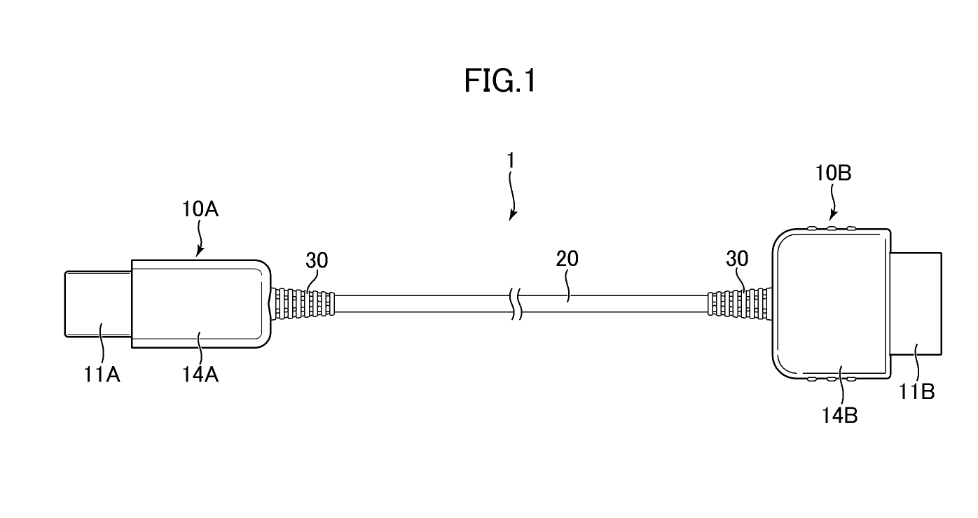

Hereinafter, an embodiment of the invention will be described with reference to the drawings. FIG. 1 is a plan view of an electronic cable 1 according to an embodiment of the invention.

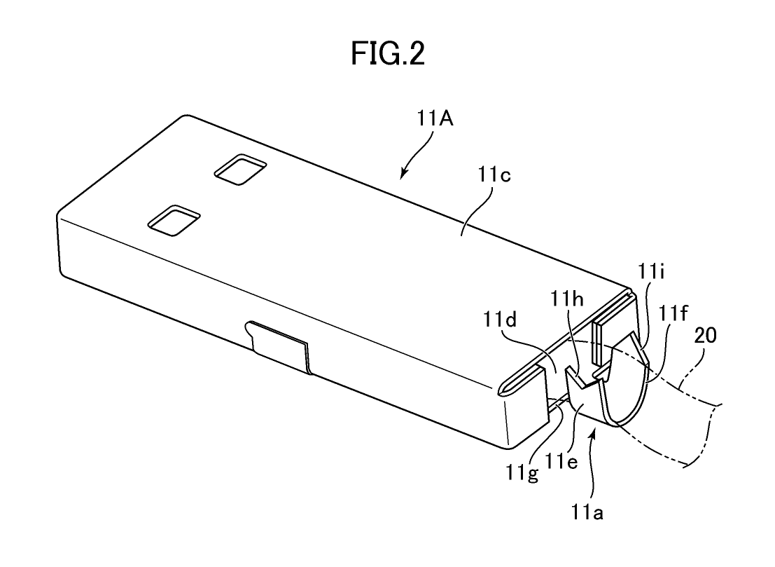

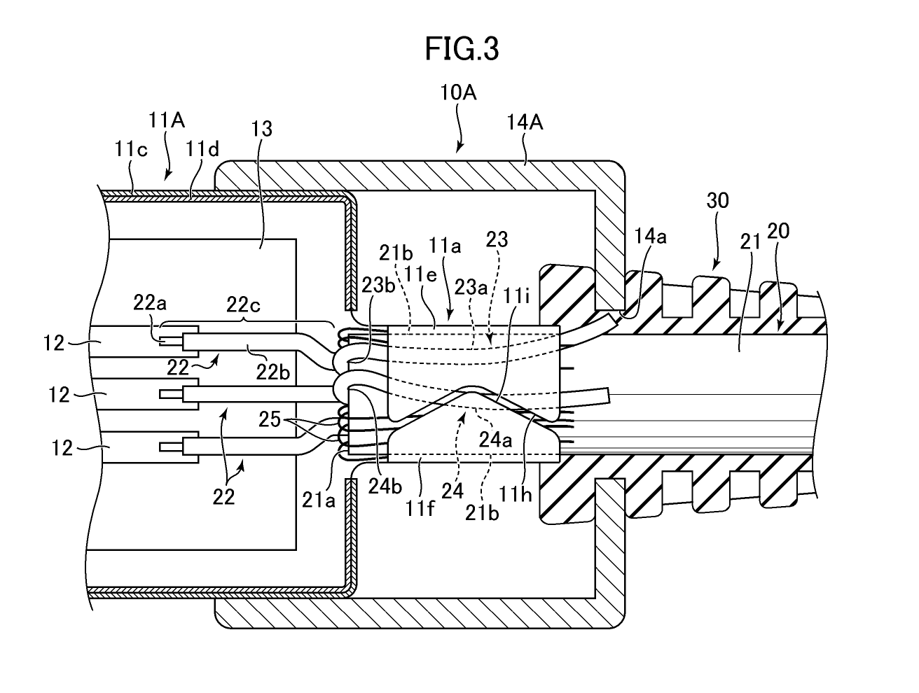

FIG. 2 is a perspective view of a shield case 11A provided on a connector 10A provided at an end of the cable 1. FIG. 3 is a horizontal sectional view of the connector 10A.

The electronic cable 1 is used for electrically connecting two electronic devices, for example, a USB cable, HDMI cable, DVI cable, Centronics cable or the like. As shown in FIG. 1, the cable 1 includes a cable main 20 and connectors 10A, 10B provided at both ends thereof. The connectors 10A, 10B are plug connectors inserted into receptacle connectors provided on electronic devices when the cable 1 is used. Although the connectors 10A, 10B in this example have different sizes from each other, these connectors may have the same size. As described later, the connectors 10A, 10B have a function of reducing a load applied to the connecting parts between terminals 12 provided in the connectors 10A, 10B and core wires 22 of the cable main 20. The structures described below are common to the connectors 10A, 10B.

As shown in FIG. 2 and FIG. 3, the connector 10A has a metallic shield case 11A. Plural terminals 12 are housed in the shield case 11A. When the connector 10A is inserted in a receptacle connector, the terminals 12 contact terminals of the receptacle connector. In this example, a plate-like base 13 is housed in the shield case 11A and the terminals 12 are mounted on the base 13. As shown in FIG. 1, the connector 10B, too, has a metallic shield case 11B. Plural terminals 12 and a base 13 are housed also in the shield case 11B.

As shown in FIG. 1, the connectors 10A, 10B have resin cases 14A, 14B covering outer surfaces of rear parts (parts toward the center of the cable 1) of the shield cases 11A, 11B. Inside the resin cases 14A, 14B, a holding portion 11a, described later, and an end of the cable main 20 are arranged. In the example shown in FIG. 3, a space is formed in the resin case 14A, and the holding portion 11a and the end of the cable main 20 are arranged in this space. However, such a space may not be formed in the resin case 14A. That is, the inside of the resin case 14A may be filled with the resin which forms the case 14A.

The cable main 20 extends toward the inside of the case 14A, 14B from an opening 14a formed in a rear part of the resin case 14A, 14B (see FIG. 3). The connector 10A, 10B has a bushing 30. The bushing 30 extends to the rear side, that is, toward the center of the cable 1, from the case 14A, 14B. In the example of FIG. 3, the bushing 30 and the resin case 14A are separate members. However, these members may be molded as a unitary member.

The cable main 20 has an outer tube 21, as shown in FIG. 3. The outer tube 21 is made of a material that is stretchable (elastic) in the length direction of the cable main 20. The outer tube 21 is made of, for example, a resin such as fluorine-containing resin, polyvinyl chloride or polyethylene, or an elastomer, and has flexibility and stretchability (elasticity) in the length direction thereof.

The cable main 20 also has the plural core wires 22 which are made of a conductor and laid through the inside of the outer tube 21. In FIG. 3, three core wires 22 are shown. However, the number of the core wires 22 may be properly changed according to the standard of the cable 1. The core wire 22 has a conductor wire 22a made of a conductor such as copper and an insulating tube 22b covering the conductor wire 22a. The core wire 22 has, at both ends thereof, a core wire end 22c extending further from the end of the outer tube 21. The core wire end 22c extends into the shield case 11A, 11B from an opening formed on a rear surface of the shield case 11A, 11B and is connected to the terminal 12, as shown in FIG. 3. That is, the end of the conductor wire 22a is soldered to the terminal 12.

The cable main 20 includes an assisting wire that is laid through the inside of the outer tube 21, as shown in FIG. 3. The cable main 20 in this example includes two assisting wires 23, 24. The assisting wires 23, 24 extend straight along the outer tube 21 within the outer tube 21, without being wound around the core wires 22 or twisted within the outer tube 21. That is, when the outer tube 21 is arranged linearly, the assisting wires 23, 24 extend linearly within the outer tube 21. The assisting wires 23, 24 are made of a material that is less stretchable than the outer tube 21. The connectors 10A, 10B fasten both ends of the assisting wires 23, 24 respectively at both ends 21b of the outer tube 21 so as to restrain movement of the both ends of the outer tube 21 in the stretch direction (that is the length direction) of the outer tube 21.

In this example, each of the both ends of the assisting wires 23 is hooked on the end 21b of the outer tube 21 so as to restrain the movement of the end 21b of the outer tube 21 in the stretch direction of the outer tube 21, as shown in FIG. 3. Similarly to that, each of the both ends of the assisting wires 24 is hooked on the end 21b of the outer tube 21. Specifically, the assisting wires 23, 24 have, at both ends thereof, folded portions 23a, 24a protruding further from the outer tube 21 and folded toward the outer surface of the outer tube 21. Bent portions 23b, 24b situated at proximal parts of the folded portions 23a, 24a are hooked on an end surface 21a of the outer tube 21. The connector 10A, 10B has the holding portion 11a which holds the folded portions 23a, 24a and the outer tube 21 (see FIG. 2). By this holding portion 11a, the ends of the assisting wires 23, 24, that is, the folded portions 23a, 24a, are fastened to the both ends 21b of the outer tube 21 and kept hooked thereon.

According to the cable 1 of this structure, the outer tube 21 is restrained from stretching by the assisting wires 23, 24. Consequently, even when the cable main 20 is bent or stretched in the length direction, a load is prevented from being applied to the connecting part between the core wires 22 and the terminals 12, that is, the soldered portion between the ends of the conductor wires 22a and the terminals 12. Specifically, the base 13 with the terminals 12 mounted thereon is connected to the outer surface of the outer tube 21 through the shield case 11A, 11B, the resin case 14A, 14B and the bushing 30. Therefore, in a structure without having the assisting wires 23, 24, when the outer tube 21 stretches, the position of the terminals 12 shifts in relation to the ends of the conductor wires 22a and consequently a load is applied to the connecting part between the ends of the conductor wires 22a and the terminals 12. According to the cable 1 having the assisting wires 23, 24, such generation of a load can be restrained.

The assisting wires 23, 24 are made of different materials from each other and have different temperature characteristics, electrical properties and bending strengths. Therefore, the outer tube 21 can be restrained from stretching securely irrespective of the environment where the cable 1 is used. In this example, the assisting wire 24 is a metal (for example, copper) wire. The assisting wire 23 is a resin thread. The outer surface of the assisting wire 23 is more flexible than the metal wire. Therefore, the folded portion 23a of the assisting wire 23 can be prevented from slipping on the holding portion 11a. Particularly in this example, the assisting wire 23 is a nylon or Kevlar (trademark registered) thread and has a high tensile strength. Thus, the assisting wire 23 can be prevented from snapping halfway. The assisting wire 23 may also be made of cotton.

The cable main 20 has plural shield wires 25 inside the outer tube 21. The shield wires 25 are intertwined within the outer tube 21 and cover the core wires 22 and the assisting wires 23, 24. As shown in FIG. 3, the ends of the shield wires 25 protrude from the outer tube 21 and are folded toward the outer surface of the outer tube 21. The ends of the shield wires 25 are held together with the assisting wires 23, 24 by the holding portion 11a. The assisting wire 24 is a thicker conductor wire than the shield wire 25.

As described above, the connector 10A, 10B has the metallic shield case 11A, 11B. The holding portion 11a is formed integrally with the shield case 11A, 11B. Referring to FIG. 2 and FIG. 3, the shield case 11A includes an upper case 11c in a shape of box opening downward, and a lower case 11d in a shape of box opening upward.

These two cases 11c, 11d are combined in an up-and-down direction, thus forming the shield case 11A. The case 11c, 11d is a member made of a single metal plate formed by press working or the like. The holding portion 11a is formed integrally with the lower case 11d. That is, in the press working to form the case 11d, the holding portion 11a is formed together with the case 11d. Also in the shield case 11B, as in the shield case 11A, the holding portion 11a is formed integrally with the shield case 11B.

The holding portion 11a is substantially U-shaped. That is, the holding portion 11a includes a pair of plate portions 11e, 11f connected to each other at bottom parts thereof, as shown in FIG. 2. The end of the cable main 20 is arranged between the plate portions 11e, 11f. The plate portions 11e, 11f are bent inward so as to contact the outer surface of the outer tube 21 tightly. That is, the plate portions 11e, 11f are caulked. In FIG. 2, the plate portions 11e, 11f before being bent inward are shown. The bottom parts of the two plate portions 11e, 11f are connected to a rear edge 11g of the lower case 11d.

As shown in FIG. 3, the end of the plate portion 11e and the end of the plate portion 11f are formed to cross with each other in the length direction (extension direction) of the cable main 20. In this example, the plate portion 11e has a recessed cross portion 11h at the end thereof. The plate portion 11f has a protruding cross portion 11i at the end thereof. With the plate portions 11e, 11f bent inward, the cross portion 11i fits inside the cross portion 11h, as shown in FIG. 3. Meanwhile, the folded portions 23a, 24a of the assisting wires 23, 24 are arranged to extend roughly in the length direction of the cable main 20. Therefore, the folded portions 23a, 24a can be prevented from being removing through the gap between the plate portion 11e and the plate portion 11f.

As described above, the assisting wire 24 is a conductor wire. The folded portion 24a of the assisting wire 24 and the ends of the shielded wires 25 are sandwiched between the holding portion 11a and the outer surface of the outer tube 21. Thus, the assisting wire 24 and the shield wires 25 are electrically connected to the shield case 11A, 11B. In this structure, the assisting wire 24 can also be used as a ground wire.

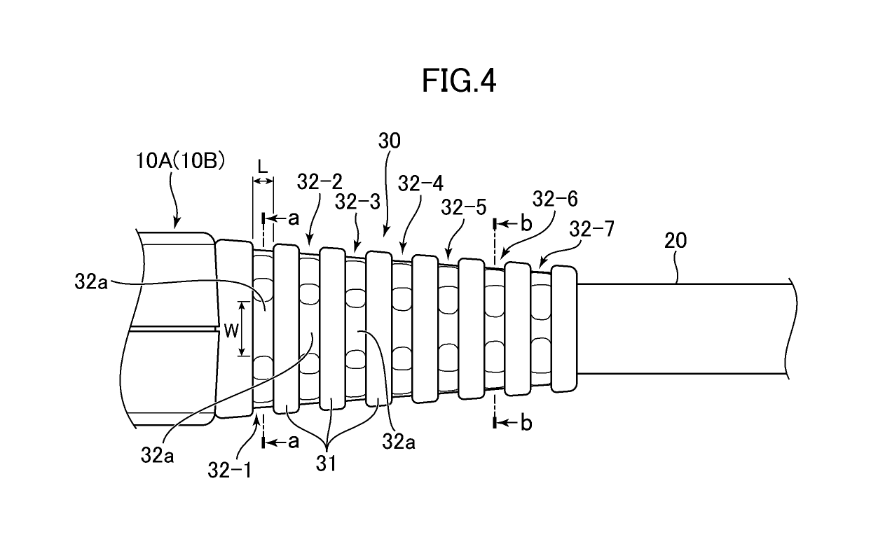

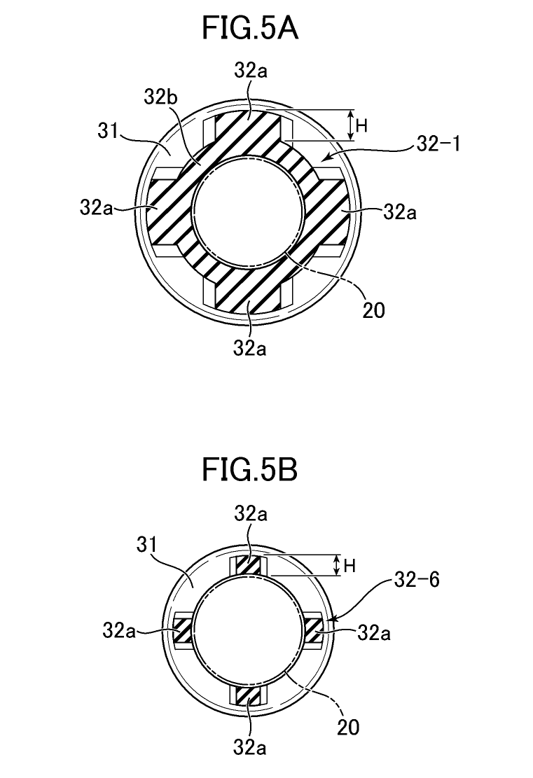

As described above, the cable 1 has the bushing 30. FIG. 4 is a side view of the bushing 30. FIG. 5A and FIG. 5B are sectional views of the bushing 30. FIG. 5A is a sectional view as viewed along line a-a in FIG. 4. FIG. 5B is a sectional view as viewed along line b-b in FIG. 4. FIG. 6 is a side view showing the state of the bushing 30 when the cable main 20 is bent in relation to the connector 10A, 10B.

As described above, the bushing 30 extends from the rear side of the resin case 14A, 14B of the connector 10A, 10B, and the cable main 20 is laid through the inside of the bushing 30. The bushing 30 is made of a flexible and elastic resin (for example, rubber) and restrains the application of an excessive load to the connecting part between the cable main 20 and the connector 10A, 10B when the cable main 20 is bent in relation to the connector 10A, 10B.

As shown in FIG. 4, the bushing 30 has plural ring portions 31 arrayed in the length direction of the cable main 20. The bushing 30 also has plural intermediate portions 32-1 to 32-7 formed between two neighboring ring portions 31. The intermediate portions 32-1 to 32-7 and the ring portions 31 are formed alternately and these portions as a whole become gradually narrower toward the rear side (that is, toward the center of the cable 1). The width L of the intermediate portions 32-1 to 32-7 in the direction of the length of the cable main 20 is approximately equal.

As shown in FIG. 5A and FIG. 5B, each intermediate portion 32-1 to 32-7 includes plural protrusions 32a arrayed at certain intervals in the circumferential direction of the cable main 20. In this example, each intermediate portion 32-1 to 32-7 has four protrusions 32a. A recessed portion is formed between two neighboring protrusions 32a in the circumferential direction. As shown in FIG. 6, when the cable main 20 is bent in relation to the connector 10A, 10B, the protrusions 32a situated on the outer side stretch in the bending direction and the protrusions 32a situated on the inner side shrink in the bending direction. Consequently, the bushing 30 becomes arcuate. Depending on the bending angle, the two neighboring ring portions 31 contact each other at inner-side portions thereof.

In the bushing 30 in this example, each intermediate portion 32-1 to 32-7 is formed such that the stretch amounts of the protrusions 32a which stretch when the cable main 20 is bent is equal among the plural intermediate portions 32-1 to 32-7. Specifically, the height H of the protrusion 32a in the radial direction of the cable main 20 (see FIG. 5A and FIG. 5B), and the width W of the protrusion 32a in the circumferential direction of the cable main 20 (see FIG. 4) are set so that the stretch amounts of the protrusions 32a are equal among the plural intermediate portions 32-1 to 32-7. Also, in this example, an annular bottom portion 32b is formed in the plural (in this example, two) intermediate portions 32-1, 32-2 which are close to the connector 10A, 10B. In the intermediate portion 32-1, 32-2, the protrusions 32a protrude radially from the bottom portion 32b. The thickness of the bottom portion 32b in the radial direction of the cable main 20, too, is set such that the stretch amount of the protrusion 32a is equal among the plural intermediate portions 32-1 to 32-7. Such a bushing 30 shows a gentle arc when the cable main 20 is bent. On the other intermediate portions 32-3 to 32-7, the bottom portion 32b is not formed and the outer surface of the outer tube 21 is exposed between the two neighboring protrusions 32a in the circumferential direction.

As described above, the cable main 20 includes the assisting wires 23, 24 that are less stretchable than the outer tube 21. The connectors 10A, 10B fasten the ends of the assisting wires 23, 24 to the ends 21b of the outer tube 21 so as to restrain movement of the ends 21b of the outer tube 21 in the stretch direction of the outer tube 21. According to such a cable 1, even when the cable main 21 is bent or stretched in the direction of the length thereof, the outer tube 21 can be restrained from stretching and thus the load applied to the connecting part between the ends of the core wires 22 and the terminals 12 can be reduced.

The folded portions 23a, 24a of the assisting wires 23, 24 protrude from both ends of the outer tube 21 and are folded toward the outer surface of the outer tube 21. The holding portion 11a holds the outer tube 21 and the folded portions 23a, 24a of the assisting wires 23, 24. According to this structure, the hooked state between the ends of the assisting wires 23, 24 and the end of the outer tube 21 can be securely prevented from being broken off.

The connector 10A, 10B has the shield case 11A, 11B housing the terminals 12. The holding portion 11a is formed integrally with the shield case 11A, 11B. According to this structure the number of components of the connectors 10A, 10B can be reduced.

The assisting wire 23 is made of a resin. Accordingly, the folded portion 23a of the assisting wire 23 can be prevented from slipping from the holding portion 11a.

The cable main 20 includes the assisting wire 23 and the assisting wire 24 which are made of different materials from each other. According to this structure, the outer tube 21 can be restrained from stretching securely irrespective of the environment where the cable 1 is used.

The assisting wire 23 is made of a resin and the assisting wire 24 is made of a metal. Therefore, temperature characteristics and electrical properties of the assisting wire 23 and the assisting wire 24 can easily be made different from each other.

The connector 10A, 10B has the metallic shield case 11A, 11B housing the terminals 12. The holding portion 11a of the shield case 11A, 11B holds the assisting wire 24 made of a conductor and the outer tube 21. The assisting wire 24 is electrically connected with the shield case 11A, 11B. According to this structure, the assisting wire 24 can function as a ground wire.

The invention is not limited to the above-described cable 1 and various changes can be made.

For example, in the above description, the cable 1 has the two assisting wires 23, 24. However, the cable 1 may be provided with one of the assisting wires. Alternatively, the cable 1 may be provided with more assisting wires.

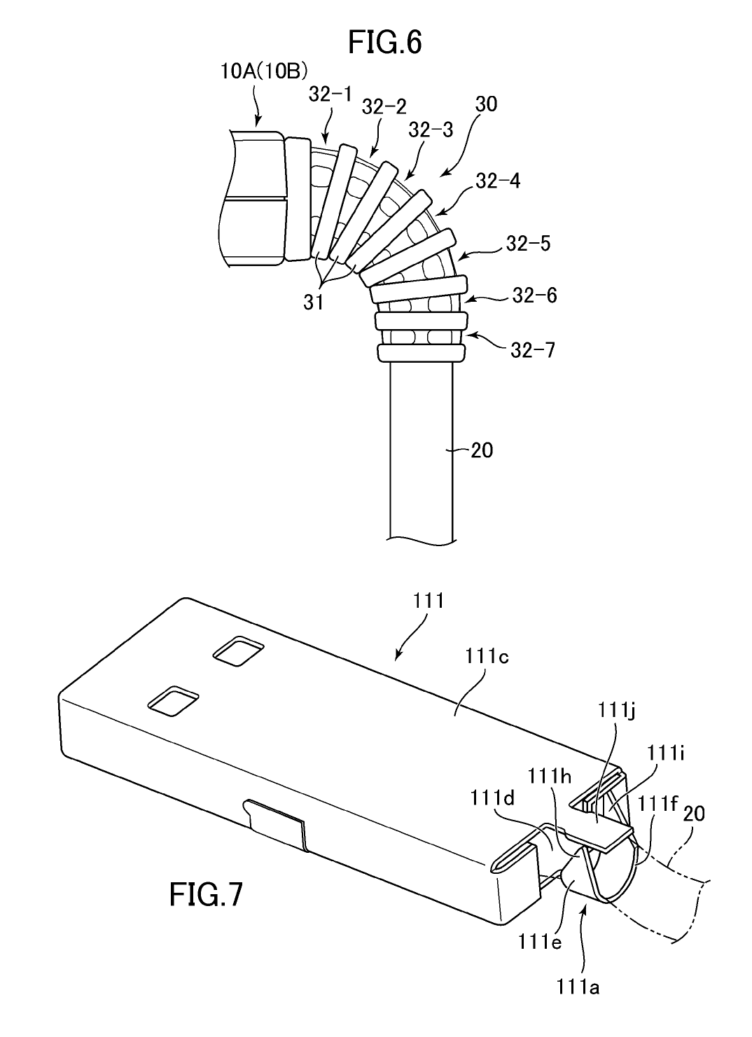

The shape of the holding portion 11a is not limited to the above-described example. For example, the holding portion of the cable 1 may be shaped as shown in FIG. 7. That is, a holding portion 111a provided on a shield case 111 shown in FIG. 7 is substantially U-shaped and has a pair of plate portions 111e, 111f connected at a bottom portion. The plate portions 111e, 111f have cross portions 111h, 111i at the ends thereof. The cross portions 111h, 111i are substantially triangular and formed with a width gradually decreasing toward the distal end. Particularly in this example, the plate portions 111e, 111i are bent inward and the boundary between the cross portions 111h, 111i is slant in relation to the length direction of the cable main 20. Therefore, the cross portions 111h, 111i cross with each other in the length direction of the cable main 20. Thus, the folded portions 23a, 24a of the assisting wires 23, 24 can be prevented from being removed off through the boundary of the cross portions 111h, 111i.

An upper case 111c of the shield case 111 shown in FIG. 7 has an auxiliary plate portion 111j. The auxiliary plate portion 111j is formed extending to the rear side from the rear edge of the upper case 111c. The plate portions 111e, 111f are bent inward so that the auxiliary plate portion 111j is situated within these plate portions. The folded portions 23a, 24a of the assisting wires 23, 24 are sandwiched between the auxiliary plate portion 111j and the outer surface of the outer tube 21. According to such a structure, a force to hold the folded portions 23a, 24a and the outer tube 21 is applied not only from the plate portions 111e, 111f but also from the auxiliary plate portion 111j. Therefore, the strength of holding the folded portions 23a, 24a can be increased. Thus, the strength of electrical connection between the upper case 111c and a lower case 111d and the assisting wire 24 can be increased.

1. An electronic cable comprising:
a cable main including an outer tube stretchable in a length direction of the cable main, a core wire laid through an inside of the outer tube, and an assisting wire laid through the inside of the outer tube and being less stretchable than the outer tube, and
connecters provided at both ends of the cable main, the connectors including terminals electrically connected to both ends of the core wire respectively, the connectors fastening the both ends of the assisting wire respectively to the both ends of the outer tube so as to restrain the both ends of the outer tube from moving in a stretch direction of the outer tube.

2. The electronic cable according to claim 1, wherein
the both ends of the assisting wire protrude from the both ends of the outer tube and are folded toward an outer surface of the outer tube, and
each of the connectors has a holding portion which holds the outer tube and the end of the assisting wire.

3. The electronic cable according to claim 2, wherein
the connector has a case housing the terminal, and
the holding portion is formed integrally with the case.

4. The electronic cable according to claim 1, wherein the assisting wire is made of a resin.

5. The electronic cable according to claim 1, comprising a first assisting wire and a second assisting wire each of which function as the assisting wire and which are made of different materials from each other.

6. The electronic cable according to claim 5, wherein
the first assisting wire is made of a resin, and
the second assisting wire is made of a metal.

7. The electronic cable according to claim 1, wherein
each of the connectors has a metallic case housing the terminal,
the assisting wires is made of a conductor, and
the case has a holding portion which holds the outer tube and the end of the assisting wire.
